(19) United States
(12) Patent Application Publication
(10) Pub. No.: US 2005/0037129 A1
(43) Pub. Date: Feb. 17, 2005

(54) Method for producing flavored and savory sausage products and products produced thereby

(76) Inventor: Kyle A. Newkirk, Greenbelt, MD (US)

Correspondence Address: GENERAL MILLS, INC., P.O. BOX 1113, MINNEAPOLIS, MN, 55440, US

(21) Appl. No.: 10/638,837

(22) Filed: Aug. 11, 2003

(51) Int. Cl. A23L 1/31

(52) U.S. Cl. 426/646

(57) ABSTRACT

The present invention relates to the production of flavored and savory meat products, namely sausage products, for use in consumer food products, including pizzas, frozen meals, snacks and the like. Additionally, the invention contemplates a binder structure for use with the meat products so as to enhance the savory characteristics of the resulting meat or sausage product.

### CROSS-REFERENCES TO RELATED APPLICATIONS

None.

### FIELD OF THE INVENTION

The present invention relates to the production of flavored and savory meat products, namely sausage products, for use in consumer food products, including pizzas, frozen meals, snacks and the like. Additionally, the invention contemplates a binder structure for use with the meat products so as to enhance the savory characteristics of the resulting meat or sausage product.

### BACKGROUND OF THE INVENTION

Dry and semi-dry sausage products are classified by the United States Department of Agriculture (“USDA”) according to their processing conditions, finished product pH, product moisture to protein ratio and various other factors. For example, in order to meet the criteria for pepperoni, the product must have a finished product moisture to protein ratio of about 1.6 to 1 and be processed under conditions specified by the USDA sufficient to kill trichinae, a harmful parasite. In order to meet the criteria for beef summer sausage, the product must have a finished product moisture to protein ratio of about 3.1 to 1 and a finished product pH of not greater than 5.0.

A conventional process for making dry and semi-dry sausage products, such as that provided in U.S. Pat. No. 5,942,265 typically includes the following steps:
(1) Admixing ground meat (pork, beef and/or poultry) with spices, curing agents and acid-producing bacteria, e.g., lactic acid-producing bacteria. Additional sources of acid such as encapsulated citric acid can also be used. The exact types and amounts of meat, spices, curing agents and sources of acid employed depend upon the type of sausage product desired. Dry sausages may or may not be characterized by a bacterial fermentation.

Next, according to conventional processing techniques, the meat mixture is formed into the desired shape by stuffing the mixture into casings of prepared animal intestine or synthetic material which are tied or sealed shut at both ends to form a single cylindrical unit or tied or sealed at intervals to form lengths. The mixture must be formed into the appropriate shape before a significant amount of acid is produced by the bacteria, released by the encapsulating material or otherwise imparted to the admixture. The acid lowers the pH of the admixture making the meat non-pliable and difficult to shape. The meat is generally easier to work with at a pH above 5.3.

Then the formed product is set in a fermenting chamber at a temperature and for a period of time sufficient for enough acid to be produced by the bacteria, released by the encapsulating material or otherwise imparted to the admixture to lower the pH of the admixture to a pH value of below 5.2, typically below 5.0. The low pH level prevents further bacterial growth and otherwise makes the product biologically stable. It also produces an acidic flavor and sets the protein in the meat thereby giving the product a firm texture. The temperature in the fermentation chamber is typically maintained between 60° F. and 105° F. for about 7 to 14 hours.

Finally, the product is dried for a period of time sufficient to obtain the required finished product moisture to protein ratio (e.g., for pepperoni, 1.6:1). For dry sausage products, the drying step must be carried out under conditions, which allow slow, controlled, uniform removal of the moisture from the product while still inhibiting the growth of surface mold or yeast. For example, the drying chamber is typically maintained at a temperature between 50° F. and 70° F. and kept relatively dry to inhibit the growth of mold or yeast. It generally requires several days or even weeks to reach the required finished product moisture to protein ratio depending upon the thickness of the formed product and other process conditions.

Some dry sausage is smoked prior to being dried but the primary production step is a relatively long, continuous air-drying process. Dry sausage typically requires more production time than other types of sausage. Dry sausage generally ranges from about 60% to about 80% of its original weight when sold. Semi-dry sausage is usually heated in a smokehouse to fully cook and partially dry the product.

Unfortunately, maintenance of the required conditions during the extended fermenting and drying steps can make mass production of dry and semi-dry sausage products somewhat difficult. Thus, there is a need for a more economical and expeditious process for making dry and semi-dry sausage products.

U.S. Pat. No. 5,736,186 to Holdren (incorporated herein by reference) discloses dry and semi-dry sausage products generally comprising highly seasoned mixtures of finely divided pork, beef and/or poultry that have been formed into a desired shape and cured. Examples of dry sausage products include pepperoni, dry salami and genoa. Examples of semi-dry sausage products include beef summer sausage, thuringer and sicilian salami. This document discloses products and a process for the preparation of a semi-dry sausage product over a very much-reduced time frame, without the need for any fermentation step.

The process described in U.S. Pat. No. 5,736,186 involves mixing meat with an encapsulated acidulant. The encapsulating material has a melting temperature of at least 90° F. The sausage mixture is formed optionally by extrusion into small pieces with a cross section no greater than 1 inch. The pieces are then heated for no more than 1 hour at a temperature from 90° F. to 500° F. This temperature melts the encapsulating material and allows the acidulant to contact the meat and lower the pH to less than 5.3, and dehydrates the product.

The process does not rely on the use of acid producing bacteria and therefore no fermentation step is required. The extrusion step, when employed in the process provides a means of producing non-conventional product shapes. The encapsulation of the acidulant in the admixture makes the admixture readily formable because the meat is soft and pliable and readily extruded.

However, U.S. Pat. No. 5,736,186 does not teach the use of an extrusion step that forms and cooks the sausage products. Nor does U.S. Pat. No. 5,736,186 teach the use of a non-encapsulated acidulant because the purpose behind the U.S. Pat. No. 5,736,186 is the prevention of the meat coming in contact with the acidulant during extrusion.

In accordance with the invention, an improved process for producing sausage products has been developed. The process contemplates the application of spices directly to the sausage product or alternatively through the use of binder systems to improve the savory affect of the meat product. The inventive process is particularly useful for producing pepperoni pieces suitably shaped and dimensioned for snack size or ready-to eat pieces or pizza toppings as well as pieces that may have a unique configuration or appearance, such as a animate object, character or ornate configuration.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one embodiment of the present invention a process for producing flavored sausage products is described and includes the steps of initially admixing an amount of ground meat with at least an amount of an edible acidulant to form a sausage admixture,; then extruding the sausage admixture into at least one shaped sausage product. Next, the sausage product is dried to achieve a desired water to protein ratio and finally, the sausage product is coated with a flavor to produce a flavored sausage product.

In a further embodiment, instead of coating the sausage product with a flavoring agent, the sausage product is coated with a starch-based binder to produce a savory sausage product.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 provides a high level flow diagram of a preferred embodiment of the present invention; and

FIG. 2 depicts a variety of shapes in which the product produced by the current process may be provided.

### DETAILED DESCRIPTION OF THE INVENTION

The present invention is now illustrated in greater detail by way of the following detailed description, but it should be understood that the present invention is not to be construed as being limited thereto.

In accordance with an exemplary embodiment of the inventive process, meat, such as pork, poultry and beef is first admixed with an acidulant to form a sausage admixture. The type of meat used depends upon the type of sausage product desired. The ground meat that is preferably used is selected from pork, beef and poultry (chicken, turkey, etc.), or mixtures thereof. Other combinations are of course possible, including alligator, bison, bear, elk, deer, ostrich, game birds and other fowl and combinations thereof. The grade of meat that is used in this process may optionally be less than that of traditional semi-dry or dry sausage products without sacrificing flavor.

The amount of fat present in the meat is also a factor. The amount of fat needed varies depending upon the type of product, flavor, etc. that is desired in the end product. For example, for pepperoni, meat consisting of at least about 90% by weight based on the total weight of the meat of finally divided raw meat selected from pork, beef, poultry and mixtures thereof, and having a total meat fat content no greater than about 58% by weight based on the total weight of the meat is very suitable. Under high temperatures or even under microwave conditions, the fat tends to melt and may render the resulting meat product unsatisfactory as it becomes too dry or unsavory. It is important in the present invention to minimize the amount of fat lost from the meat and to ensure that the ability of the meat product to bind when extruded is maintained and for the addition of a flavor coating to bind with the meat product.

As used herein and in the appended claims, the term “acidulant” denotes any food grade acid as well as compounds, which react with water to generate food grade acids such as glucono-δ-lactone. A food grade acid is an acid, which is suitable for human consumption, United States purity grade and approved by the USDA. Examples of food grade acids that can be used include citric acid, lactic acid, acetic acid, sorbic acid, tartaric acid, isoascorbic acid, adipic acid and mixtures thereof. The acidulant used in connection with the present invention is preferably selected from the group consisting of glucano-δ-lactone, lactic, malic, citric, acetic, isoascorbic, adipic, tartaric, sorbic acid and mixtures thereof. The acidulant and the preferred amount of ground meat to the amount of acidulant ratio ranges between about 99:1 to about 95:5 by weight.

The acidulant must be used in an amount and have a strength sufficient to lower the pH of the sausage admixture to a value no greater than about 5.3 in the resulting meat product. Preferably, the acidulant is used in an amount and has a strength sufficient to lower the pH of the sausage admixture to a value between about 5.0 and about 4.1. The exact pH will vary depending in part on the type of sausage product, flavor desired, and the like. For example, for pepperoni, the acidulant is preferably employed in an amount and has a strength sufficient to lower the pH of the sausage admixture to a value of about 4.3. Such a low pH enhances the flavor of pepperoni.

The exact amount of the acidulant required depends in part on the initial pH of the meat, the desired pH of the meat, the buffering capacity of the meat, the type and amount of additives admixed with the meat and the strength of the specific acidulant used. Generally, the amount of acidulant that must be employed is in the range of from about 1% by weight to about 5% by weight based on the weight of the meat.

One or more spices, seasonings and one or more curing agents may also be optionally employed in the initial sausage admixture. These ingredients are preferably admixed with the ground meat at the general time the acidulant is admixed with the meat. The particular spice(s) and/or curing agent(s) employed depend on the end product desired. Examples of spices that can be used include white pepper, anise, fennel, red pepper, oregano, black pepper and mixtures thereof. Examples of curing agents that can be used include sodium nitrite, sodium erythorbate, potassium nitrite, potassium nitrate, sodium nitrate and mixtures thereof. If spices are used, they are generally employed in a total amount of from about 1% to about 6% by weight based on the weight of the meat. The amount of the curing agents used varies depending on the particular agent(s). For example, sodium nitrite and potassium nitrite are each used in an amount of 0.25 ounces per 100 pounds of meat. Sodium nitrate and potassium nitrate are each used in an amount of 2.75 ounces per 100 pounds of meat. The curing agents function to retain substantially the original meat color and kill trichinae.

Additional ingredients including extenders can be admixed with the meat as known to those skilled in the art of sausage making. Such additional ingredients are preferably added to the sausage admixture at about the same time the acidulant, spices, curing agents and/or protein source are admixed with the meat.

It will be appreciated that the acidulant, spice(s), curing agent(s), protein source and any other ingredients employed can be admixed with the meat by any method that uniformly distributes the ingredients throughout the meat. In the present invention, a conventional meat blender can be employed. Generally, about 2 to about 5 minutes mixing time is sufficient. The meat is typically provided in a chopped, ground, diced, minced or otherwise finely divided condition, however, for the purposes of this invention, the meat is provided in a most preferably ground condition, prior to admixing the acidulant and other ingredients therewith. A suitable sausage as provided in the exemplary embodiment is obtained through the admixture which includes the ground meat, then blending the ground meat with the acidulant and other ingredients to form the sausage admixture and then grinding the entire sausage admixture prior to the forming step.

Once the meat is admixed with the encapsulated acidulant and any other ingredients employed to form a sausage admixture, the sausage admixture is extruded and simultaneously cooked into at least one shaped sausage product, preferably a plurality of shaped sausage products (such as a plurality of nuggets, tubes, links or the like). Each shaped sausage product formed must have a thickness and overall shape that allows sufficient heat exchange and moisture transfer in the subsequent drying step. It has been found that sufficient heat exchange and moisture transfer in the drying step can be achieved if each sausage product formed has at least one cross-sectional dimension (e.g., length, width, height, diameter) no greater than 2 inches. Each shaped sausage product formed preferably has at least one cross-sectional dimension no greater than 1 inch, more preferably at least one cross-sectional dimension in the range of from about 1/16^{th} inch to about 1/2 inch.

In one embodiment, the sausage admixture is formed into a plurality of sausage products, in either sheets or strips each having at least one cross-sectional dimension no greater than approximately 1 inch, preferably no greater than about 1/2 inch.

Once the product has been extruded and cooked the resulting sausage products can then be further optionally cut/sliced or diced into smaller shaped two-dimensional or three-dimensional products prior to the drying step. Conventional cutting/slicing or dicing equipment may be used. Preferably the process may be utilized to produce novel shaped pieces, such as pepperoni pieces that are snack sized, or pepperoni pieces that are suitable for use as pizza or other food toppings.

The extrusion device that is employed for the invention can be achieved using a simple extruder such as a VeMag-type stuffer. The inventors have found that the pressure at which the extrusion step is conducted is not an important aspect of the process and that it is possible to achieve well-extruded products with good surface properties at high extrusion rates such as up to 5000 pounds per hour. The temperature at which the extrusion process is conducted is preferably between the ranges of about 20° F. to about 120° F.

In general, the smaller the dimensions of the shaped sausage product(s) formed the greater the rate of heat penetration and moisture removal achieved in the heating step. As such, through use of the present invention the nature of the extrusion process facilitates the production of nuggets and other sausage products having non-conventional shapes thereby permitting the manufacturer to further differentiate its products in the marketplace.

Once the sausage admixture is formed into one or more shaped sausage products, the product(s) are heated and dried until the desired moisture to protein ratio in the product is achieved. In the present exemplary embodiment, the drying time is less than about 1 hour and that the drying temperature is conducted at a temperature of between about 150° F. to about 225° F. More preferably, the drying temperature is conducted in a range between about 170° F. to about 210° F.

For sausage that contains pork, it is important to heat the product(s) at a temperature and for a period of time that is also sufficient to assure that trichinae and any harmful bacteria is destroyed in accordance with U.S.D.A. regulations. For example, for pepperoni, it is necessary to heat the product(s) at a temperature and for a period of time sufficient to raise the internal temperature of the product(s) to at least about 150° F. and more preferably to at least about 170° F. Trichinae is destroyed in accordance with the inventive process by the curing and heating aspects of the current inventive process. USDA prescribed treatments of pork and products containing pork are set forth in the Code of Federal Regulations, Section 318.10 (May, 1985), which is incorporated by reference herein.

It will be appreciated that the length of time of the heating/drying step will vary depending on many process parameters and factors including the type of product(s) being produced and the particular requirements therefor, including the initial amount of moisture in the product(s), the shape of the product(s) being heated, the temperature being used and the type of heating apparatus being used.

The drying step can be carried out using many different types of heating devices, including but not limited to linear forced air dryers/oven, vacuum dryers, spiral forced air dryers, batch ovens and the like.

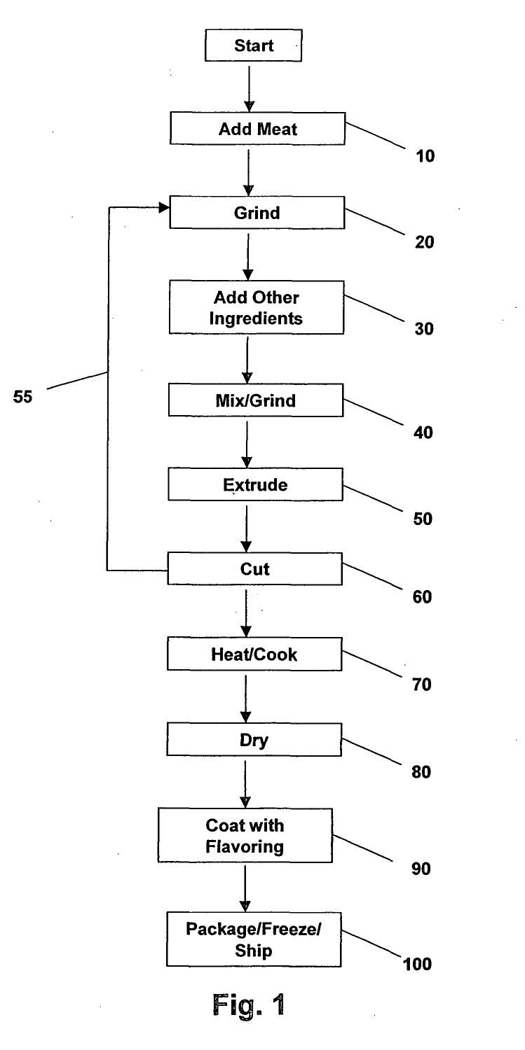

In an embodiment, the inventive process as illustrated in FIG. 1 is employed on a continuous basis to mass-produce dry or semi-dry sausage products. First meat is added to at step 10. The meat is then ground at step 20. Next, additional ingredients including an acidulent, spices, etc. are added to the ground meat at step 30. The mixture is again ground and mixed at step 40. Next, the mixture is extruded at step 50 into casings as described above. The extruded material is cut at step 60 and cuttings may then be fed back or “recycled” via a pipe, conveyor, vacuum tube or the like illustrated as line 55 to the grinding step 20. After the extrudate is cut, it is then heated at step 70, dried at step 80 to produce a sausage product. It should be understood that the heating and drying step preferably occur simultaneously but are illustrated in FIG. 1 as separate steps for convenience. Next, the product is then either coated with an additional flavoring agent or is placed within a slurry to coat the product as described below at step 90. The product may then be prepared for packaging, freezing or distribution at step 100.

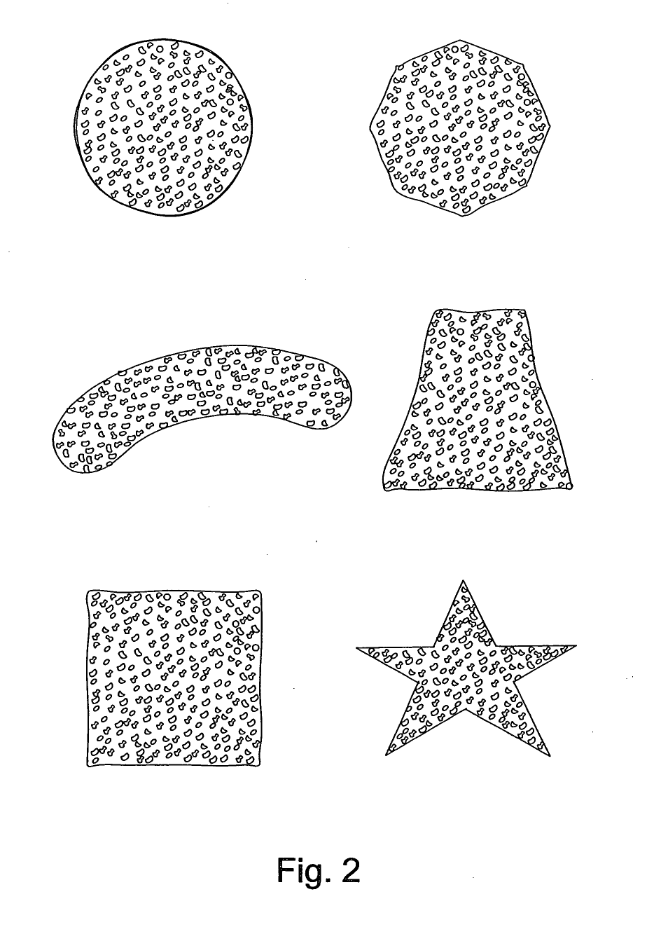

Turning briefly to FIG. 2, the illustration depicts a number of configurations and shapes that may be produced in connection with the present embodiment. Other configurations, shapes, designs, etc. are of course possible.

In order to further illustrate the inventive process, the following examples are given. Although the examples are presented to illustrate certain specific embodiments of the invention, they are not to be construed to restrict the scope and spirit of the invention.

### EXAMPLE 1

A sample of dry sausage (pepperoni) was produced in accordance with the inventive process.

First, the meat, approximately 5 kg, was ground (step 20) and then admixed with the other ingredients including an acidulant, spices, seasonings, a curing agent and a protein source to form a sausage admixture (steps 30 and 40 in FIG. 1). The meat consisted of a mix of beef and pork in a range of approximately 30% beef and 70% pork. The beef and pork were ground together in a conventional meat grinder prior to being admixed with the other ingredients. The total fat content in the meat was about 35% by weight based on the weight of the meat (meat referring to the meat mix).

The acidulant is a combination of citric and lactic acid and was used in an amount by weight relative to the meat of approximately 1.5% each.

The spices and seasonings used were conventional sausage or Italian seasonings obtained from Chris Hanson Corp. and included approximately 5% by weight of the batch prepared.

The ground meat mix was admixed with the acidulant, spices, seasonings, curing agent in a conventional meat blender for approximately 4 minutes.

Next, the sausage admixture was continuously extruded into a plurality of rectangular strips, each strip being approximately 4 inches wide and ⅜ of an inch high. The strips were extruded by loading the sausage admixture into an extrusion chamber and using a piston to push the admixture through an extrusion head.

The resulting extruded sausage product was then cut into shapes or pieces having the following dimensions one and half inches (½″) by one and half inches (½″).

The heating device through which the pepperoni pieces were dried was a batch oven operating at a temperature of approximately 150° F. and the time required for drying was approximately 30 minutes.

A few of the pieces were analyzed upon exiting the oven. The pieces looked and tasted like conventional pepperoni, had a pH level of around 4.3 and a moisture to protein ratio of 1.6:1 or less.

Once the drying step is completed, the sausage product coming out of the dryer will have a thin film or coating of fat on the exterior of the sausage product, which is a result of the relatively high fat content of the original meat product and the effect of heating the meat product under elevated temperatures. Use of the acidulent has reduced the amount of fat that is cooked off during the heating and/or drying.

In one embodiment, the cut, sliced and or diced pieces of sausage are then coated or enrobed with a starch binder matrix consisting of a starch such as a low amylose corn starch and flavorings. To the binder is added a flavoring agent. These flavorings may include but are not limited to cheddar cheese, nacho cheese, blue cheese, ranch, sour cream, barbeque, pepper spices, Italian seasonings, onion, garlic, curry, Thai, teriyaki, mesquite, combinations thereof and such other flavors as one may desire.

The invention provides an enrobing slurry that is formed from the combination of the starch and the flavorings for coating the outer surface of the sausage product.

In some instances the use of a starch may not be necessary as the flavorings may bind directly to the fat on the exterior of the sausage product that is produced as a result of the heating and or drying steps. That is fat containing products have a tendency to have the fat cooked off during such heating and the fat serves as the binding agent to hold the flavoring to the sausage product.

In another embodiment the slurry only contains a starch and no flavoring agent is added so that when the sausage pieces are added to a sauce, such as with a sauce used in the preparation of pizza, snack products, frozen entrees or the like, upon heating of the food product for food preparation or consumption, the starch binder serves to retain the fat that is typically cooked off during the food preparation step. This leads to the sausage product retaining its characteristic flavor of the sausage resulting in a more savory product as opposed to one in which the sausage product may appear to be dried out. In addition, it has been discovered that where a sausage product of the present invention is added to a ready to eat type food product containing sauces that the sauce with the sausage and coating has improved viscosity as opposed to sausage and sauce combinations in which the sausage product has not been coated with the binder.

In an exemplary embodiment, where a binder solution is provided in a slurry, the cut sausage pieces were then dipped, tumbled or otherwise coated in one of the slurries described above. The sausage pieces were then drained to remove excess amounts of the slurry resulting in a sausage product having a coating weight of between about 0.1 to about 20% by weight of the sausage product and more preferably about 0.5 to about 3% by weight.

In a still further exemplary embodiment of the present invention, the sausage pieces prepared in accordance with the following:

| Ingredient | Percentage | Weight |
|---|---|---|
| Sausage | 80% | 3995.2/gm |
| Water | 16.2% | 809.02/gm |
| Salt | 1.5% | 74.91/gm |
| Dent Corn Starch | 0.4% | 19.98/gm |
| Flavorings | 1.9% | 94.9/gm |
| Total | 100% | |

Each of the ingredients for the exemplary formulation were initially measured out and were added to the water and the solution mixed. In the above example, the mixture will be referred to as the marinade.

A dent corn starch, such as Melojel is an amylose containing food grade starch, derived from corn (approximately 25% amylose) and is available from National Starch of Bridgewater, N.J.

The salts used herein may be sodium chloride, potassium chloride or mixtures thereof.

The sausage pieces are then placed in a tumbler and the marinade added. A vacuum is pulled to a minimum of 22 to about 30 inches with about 25 to 30 inches being preferred. The sausage/marinade combination is then tumbled for approximately 30 minutes. After the tumbling periods were complete, the contents of the vessel were emptied and placed in a cooler. The tumbling or marinating time period can range from about 15 minutes to around an hour.

The remaining dried and suitably shaped products can then be packaged, chilled, optionally frozen and shipped/stored as required.

### EXAMPLE II

An additional sample of dry sausage (pepperoni) was produced in accordance with the inventive process.

First, the meat, approximately 5 kg, was ground and then admixed with an acidulant, spices, seasonings, a curing agent and a protein source to form a sausage admixture. The meat consisted of a mix beef and pork in an amount of about 30% beef and about 70% pork. The beef and pork were ground together in a conventional meat grinder prior to being admixed with the other ingredients. The total fat content in the meat was about 33% by weight based on the weight of the meat (meat referring to the meat mix).

The acidulant is a combination of citric and lactic acid and was used in an amount by weight relative to the meat of approximately 1.5% each.

The spices and seasonings used were conventional sausage or Italian seasonings obtained from Chris Hanson Corp. and included approximately 5% by weight of the batch prepared.

The ground meat mix was admixed with the acidulant, spices, seasonings, curing agent in a conventional meat blender for approximately 6 minutes.

Next, the sausage admixture was continuously extruded into a plurality of rectangular strips, each strip being approximately 4 inches wide and about 1/2 inches high. The strips were extruded by loading the sausage admixture into an extrusion chamber and using a piston to push the admixture through an extrusion head.

The resulting extruded sausage product was then cut into shapes or pieces having the following dimensions ¼″ by ½″ to 2″ by 2″.

The heating device through which the pepperoni pieces were dried was a batch convention oven operating at a temperature of approximately 120° F. The time required for drying was about 30 to 45 minutes.

A few of the pieces were analyzed upon exiting the oven. The pieces looked and tasted like conventional pepperoni, and had a pH level of 4.4 and a moisture to protein ratio of 1.6:1 or less.

In this example, the procedure after drying is followed, however no flavoring agent is added to the slurry and the sausage pieces are coated in a starch based binder. Upon cooking of the pizza, snack or other food product the starch coating on the sausage pieces serves to retain the fat from being cooked off during the heating thus retaining the savory flavor of the sausage product.

Thus, the present invention is well adapted to carry out the objects and attain the ends and advantages mentioned as well as those, which are inherent therein. The preceding examples can be repeated with similar success by substituting the generically or specifically described components and/or operating conditions of this invention for those used in the examples.

Furthermore, although certain preferred embodiments of the invention have been described for illustrative purposes, it will be appreciated that various modifications and innovations of the process recited herein may be effected without departure from the basic principals, which underlie the invention. Changes of this type are therefore deemed to lie within the spirit and scope of the invention except as may be necessarily limited by the appended claims and reasonable equivalents thereof.

It will thus be seen according to the present invention a highly advantageous process for producing savory and flavored sausage products has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A process for producing flavored sausage products, comprising the steps of
i) admixing an amount of ground meat with at least an amount of an edible acidulant to form a sausage admixture,
ii) extruding the sausage admixture into at least one shaped sausage product;
iii) drying the shaped sausage product to achieve a desired water to protein ratio; and
iv) coating the shaped sausage product with a flavor to produce a flavored sausage product.

2. A process as recited in claim 1, including a further step of cutting, slicing or dicing the sausage admixture after the step of extruding.

3. A process as recited in claim 1, including a further step of supplying the flavored sausage product to a consumer food product.

4. A process as recited in claim 3, wherein the consumer food product is selected from a group including pizza, snack foods and frozen dinner.

5. A process as recited in claim 1, wherein the flavor is selected from a group including cheddar cheese, nacho cheese, blue cheese, ranch, sour cream, barbeque, pepper spices, Italian seasonings, onion, garlic, curry, Thai, teriyaki, mesquite, combinations thereof.

6. A process according to claim 1, further including the step of forming the cooked and extruded sausage product into desired two dimensional or three dimensional shapes and sizes.

7. A process according to claim 1, wherein the ground meat is selected from a group including pork, beef, poultry, alligator, bison, bear, elk, deer, ostrich, game birds and other fowl and combinations thereof.

8. A sausage product prepared according to the process recited in claim 1.

9. The sausage product according to claim 8, which is shaped and dimensioned into snack size, toppings for food products, pizza toppings or ready-to eat pieces.

10. The sausage product as recited in claim 8, wherein the sausage product is provided in the shapes of any of animate, themes, characters, stars, squares, rectangles, hexagonals, pentagonals or combinations thererof.

11. The sausage product as recited in claim 8, wherein the sausage product is flavored with a flavoring selected from a group including cheddar cheese, nacho cheese, blue cheese, ranch, sour cream, barbeque, pepper spices, Italian seasonings, onion, garlic, curry, Thai, teriyaki, mesquite, combinations thereof.

12. The sausage product as recited in claim 8, wherein the sausage product is formed into two-dimensional or three-dimensional shapes and sizes.

13. The sausage product as recited in claim 8, wherein the sausage product is formed from a ground meat that is selected from a group including pork, beef, poultry, alligator, bison, bear, elk, deer, ostrich, game birds and other fowl and combinations thereof.

14. A process for producing savory sausage products, comprising the steps of
i) admixing an amount of ground meat with at least an amount of an edible acidulant to form a sausage admixture,
ii) extruding the sausage admixture into at least one shaped sausage product;
iii) drying the shaped sausage product to achieve a desired water to protein ratio; and
iv) coating the shaped sausage product with a starch containing binder to produce a savory sausage product upon heating.

15. A sausage and sauce combination, comprising;
a source of sausage;
a starch based binder solution which is coated on to the sausage;
a sauce for inclusion in a food product; and
wherein the sausage coated with the starch based binder solution is added to the sauce to create a sauce and sausage combination that has improved viscosity when pumping the sauce and sausage combination to a consumable food product.

16. A sausage and sauce combination as recited in claim 15, wherein the starch based binder solution includes a flavoring agent.

17. A sausage and sauce combination as recited in claim 15, wherein the flavoring agent is selected from a group including cheddar cheese, nacho cheese, blue cheese, ranch, sour cream, barbeque, pepper spices, Italian seasonings, onion, garlic, curry, Thai, teriyaki, mesquite, combinations thereof.

18. A sausage and sauce combination as recited in claim 15, wherein the consumer food product is a pizza roll.

19. A sausage and sauce combination as recited in claim 18, wherein the consumer food product is a pizza.
